(19) United States
(12) Patent Application Publication
(10) Pub. No.: US 2014/0027988 A1
(43) Pub. Date: Jan. 30, 2014

(54) METHOD AND DEVICE FOR CONTROLLING THE DAMPING OF A VEHICLE THAT IS ABLE TO BE PROPELLED BY THE DRIVER

(71) Applicants: Lars OLEMS, Stuttgart (DE); Philipp SCHOTT, Weinstadt (DE)

(72) Inventors: Lars OLEMS, Stuttgart (DE); Philipp SCHOTT, Weinstadt (DE)

(73) Assignee: ROBERT BOSCH GMBH, Stuttgart (DE)

(21) Appl. No.: 13/933,606

(22) Filed: Jul. 2, 2013

(30) Foreign Application Priority Data
Jul. 24, 2012 (DE) DE 102012212949.9

(51) Int. Cl. B60G 17/016

(52) U.S. Cl. CPC B60G 17/016
USPC 280/5.515

(57) ABSTRACT

A method and a control unit, using which the damping of one or more damping elements on a vehicle that is able to be propelled by the driver, particularly a bicycle, is able to be varied. The propelling power of the driver or his behavior during the operation of the vehicle is recorded, in order to control or regulate the damping of the damping element as a function thereof. This is achieved by the setting of the damping taking place as a function of a power variable, which represents the propelling power of the driver or his behavior.

### FIELD OF THE INVENTION

The present invention relates to a method for controlling the damping of one or more damping elements, as well as a control unit for a vehicle that is able to be propelled by a driver, a bicycle in particular, which carries out such a method.

### BACKGROUND INFORMATION

During travel of a vehicle over an uneven roadway, this unevenness is regularly perceived by the passengers as shocks. In order to prevent this transmission or even to avoid it, shock absorbers have long been built into the chassis, which intercept rougher or lesser shocks, depending on the setting of the suspension. Besides a fixed setting of the damping properties, a variable setting is also possible. Thus, a method is known from German Published Patent Application No. 10 2007 051 226, in which the shock absorbers of a vehicle are controlled electronically, and thus the damping is able to be regulated. Consequently, the damping setting may be undertaken with the aid of the detected road conditions, for example. By contrast, in classical bicycle design, often rigid bicycle forks are used, in which shock transmissions may occur onto the handlebar, caused by unevenness in the roadway, and thus onto the cyclist. However, with the spread of mountain bikes, spring forks have proven successful, which are able to cushion the shocks. Besides installing them directly on the spring fork, there is also the possibility of setting the spring action during travel, via a mostly hydraulic line that is connected to the handlebar using a lever.

### SUMMARY

A method and a control unit are described in the present invention, using which the damping by one or more damping elements, on a vehicle propelled by the driver, a bicycle in particular, may be varied. According to the present invention, in this context, the propelling power of the cyclist, or his behavior during his operation of the vehicle, is recorded, in order to control or regulate the damping of the damping elements as a function of it. This is achieved in that the setting of the damping takes place as a function of a power variable, which represents the propelling power of the cyclist and his behavior.

Using this invention, one may consequently achieve that the damping effect of the at least one damping element is automatically adjusted to the travel situation. In this context, the system detects by itself to what extent the increase or the reduction in the damping is required, while the behavior of the driver is taken into account, for instance, while treading on the pedals. Thereby, unnecessary damping processes may be reduced, e.g. during uphill travel. Instead of compensating for the force raised by the cyclist, using the damping elements, the cyclist is thus able to apply more force to the propulsion.

For the better recording of the propelling power, the power variable may be a function of the torque that is present at a pedal crank bearing located on the vehicle. Correspondingly, sensors may also be used that have been inserted into the pedals of the vehicle in order to detect the treading force of the cyclist.

It is of particular advantage if, in addition, the curve over time of the power variable is recorded. Thus, the damping may be increased or reduced in a specified manner at certain points in time. By taking into account the roadway, one is additionally able, optionally, to recognize whether cushioning of the shocks caused by an uneven roadway is an obstacle to transmitting the muscle power of the cyclist onto the drive. Thus, for example, during level travel, the damping may be reduced, i.e. the damping element be set more rigidly according to trends, since no shocks are to be expected. On the other hand, when taking into account information on an incline, it may be detected whether travel is downhill, so that the cushioning of shocks is of advantage.

In a further embodiment of the present invention, the torsion or rotation of the bicycle frame may also be detected, for instance, via strain gauges, that are fastened in, or on the frame. By taking into account this torsion or rotation, it may be detected whether, during driving, the cyclist is applying particularly great force. In that case, it is provided that the damping should be reduced, so that less, to no energy is diverted by using the damping.

Furthermore, it may be provided that one should take into account the force which the cyclist exerts on the pedals when setting and regulating the damping. Thus, during a strong start, i.e. during a high stress of the pedals, the damping may be reduced or regulated entirely down to zero. By contrast, the damping may also be increased when the system detects, owing to a lower load on the pedals, that the cyclist is not applying great force for driving. This is regularly the case, for example, in so-called downhill travel in which, in rapid sequence because of the downhill travel, shocks are able to be transmitted onto the handlebar, without the cyclist contributing substantially to propelling the vehicle.

In one particular embodiment of the present invention, it is provided for the pedal position to be detected, so as to establish the points in time for the adjustment of the damping of the damping element. Thus, in the case of a pedal position in the first or third quarter, it may be assumed that the driver is applying a greater force, and consequently a higher torque on the pedal crank and the drive. In this case, higher damping, that is, compensation of the vibrations, for example, between the handlebar and the front wheel would be counterproductive. Therefore, the present invention provides, in this case, that one should reduce the damping or even to set it to zero. By contrast, in a pedal setting detected to be in the second or fourth quadrant, the damping is increased, if necessary even raised to maximum damping.

The method may advantageously run on a control unit which is mounted on a bicycle, and is connected (electrically) to the damping element. When the present invention is used within the scope of an electric bicycle, the control unit may be integrated into the normal controller of the drive, and perhaps take data on the power variable directly from this controller.

Additional advantages are given in the subsequent description of exemplary embodiments as well as the dependent claims.

### BRIEF DESCRIPTION OF THE DRAWINGS

FIG. 1 shows a bicycle having the components required for the present invention.

FIG. 2 shows a flow chart according to the present invention.

FIG. 3 shows a block diagram of a specific embodiment of the present invention.

### DETAILED DESCRIPTION

To avoid the transmission of shocks to the front wheel on the handlebar of a bicycle 100 and thus to the wrists or arms of the cyclist, special spring forks are used which include shock absorbers having damping elements 110. The purpose of these shock absorbers is that, corresponding to an electric circuit, a (high-pass) filter is used which filters out certain (shock) frequencies.

Damping elements currently available normally use oils that are guided through adjustable bores, so as to achieve the damping effect.

Occasionally, however, damping elements are offered that work using air. Whereas in the case of normal spring forks having shock absorbers the damping is able to be set manually directly on the damping element, in more costly shock absorbers, possibilities for setting are available which enable changing the damping even during travel. For this, a lever is mounted on the handlebar which is connected to the damping element via a, most commonly, mechanical or hydraulic connection.

One further possibility of preventing the transmission of shocks from the bicycle to the cyclist, during travel, is to mount a damping element 120, such as a spring that is variable in its damping, in the fastening area of seat 130. By doing this, it may be prevented that the shocks, which occur, for example, in response to a very rough roadway having potholes, are transmitted to the backbone of the cyclist.

In conclusion it may also be provided that one should connect the rear wheel to the remaining frame 180 using a joint, and to apply a spring system (not shown) between the frame and the rear wheel suspension. Using such a design, especially in cross-country trips or downhill trips, one is able to achieve better adaptation to the existing underground. In the case of this spring system it is also conceivable that one should insert a damping member.

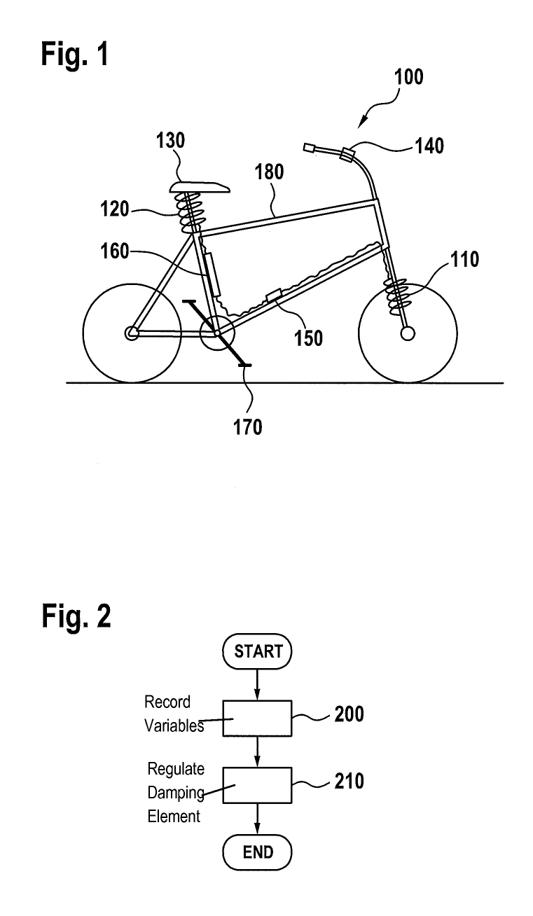

FIG. 1 schematically shows a bicycle 100, in which a shock absorber having a damping element 110 as well as a seat 130 having a damping element 120 are provided. In the case of an electric bicycle, a battery 160 may additionally be provided which is fastened to frame 180. On the handlebar, a tachometer, an operating and control element 140 (such as an HMI—human-machine-interface)or other type of display unit may be provided which records and displays the current travel data. The current travel data may be ascertained via sensors 150, in this instance, which are mounted, for example, on the frame, the wheels or the pedals 170, or on the pedal crank.

The procedure in principle of the method according to the present invention is shown in the flow chart of FIG. 2. In a first simple exemplary embodiment, after the start of the algorithm, in a first step 200, for example, the propulsion power of the cyclist or the drive torque, in the form of a power variable, is recorded, whereupon in a second step 210 the damping element is actuated. This algorithm may be run through once in the variants shown, and started anew at fixed or optional times or at specified situations (e.g. at a detected roadway unevenness or the propulsion power of the cyclist which exceed a certain threshold value. Alternatively, however, an endless loop may be provided (if necessary, having a separate break-off condition which at rest states during a definite time), with the aid of which the damping is able to be constantly adjusted to the current drive power.

The essence of the present invention is that the damping is reduced when the cyclist is generating a greater drive power. This may even lead to the damping being totally blocked, so that the handlebar and the front wheel are connected rigidly via the spring fork. This could be the case if the cyclist rides his bicycle up an hillside, and, using the support of his arms on the handlebar, intends to exert greater drive torque on the pedals and thus the pedal crank. In this case, additional damping of the spring fork would be counterproductive. In the contrary case, the damping could also be increased or even maximized, if it is detected that only a small drive power is required of the cyclist, for example, during downhill travel, or if during travel shocks are to be expected which should be kept away from the cyclist.

In a further exemplary embodiment, it may be provided in step 200 that additional variables are recorded which represent both the travel behavior and the travel environment. From these variables, in step 210 an optimized actuation or regulation of the damping element may then take place. Thus, it is conceivable that, via suitable sensors 330 to 390, the treading force of the cyclist on pedals 170, the generated torque on the pedal crank, the torsional force acting upon the frame, the pedal position, the acceleration of the bicycle or another variable is recorded and taken into account during the actuation. In addition, the condition of the roadway or the underground may also be taken into account, by recording the inclination, for example, the frequency of shock or, in general, the unevennesss.

The methods described may be integrated in a separate control unit or in an already existing display unit, operating unit or control unit. Thus, for example, in an electric bicycle, HMI 140 may be utilized to take over, simultaneously with the already present power data or travel parameters, the control of damping element 110 and 120. In this case, the power supply for the control or regulation of the damping is also ensured by battery 160 that is present on the electric bicycle. Apart from that, one should take care that the control unit is supplied with appropriate power.

In one further exemplary embodiment it may be provided to store both the recorded sensor values of the travel parameters and the control data for later evaluation, or to transmit them by wireless (e.g. WiFi or Bluetooth) to an external device (such as a Smart Phone). By this transmission or storing, the travel profile and the sensor values or the control data are able to be analyzed at a later time, on a PC, for example. In this connection, linking these to currently recorded GPS values may be meaningful, in order to achieve a local association with the values or the data.

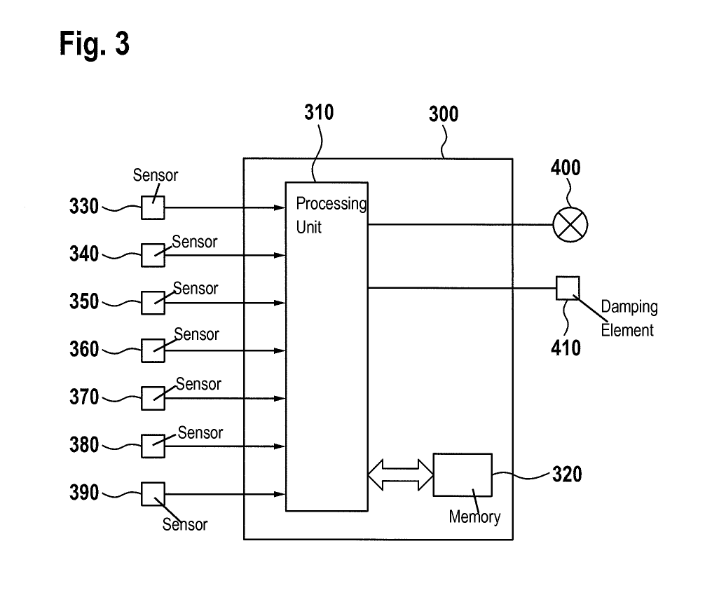

One possible embodiment of the present invention is shown in FIG. 3 with the aid of a block diagram. The central element, in this instance, is a control unit 300, which has a processing unit 310 as well as, optionally, a memory 320, which is connected to processing unit 310 in such a way that the data may be exchanged.

A power variable is read into processing unit 310 in one basic variant, which originates from a corresponding sensor or recording device 330. Based on this power variable, the actuation of damping element 410 is derived, in processing unit 310. This may be done both by underlying comparative tables, relationships, but also via reaching threshold values which are optionally filed in memory 320. In one particular embodiment it may be provided that the actuation and/or change of the damping be provided additionally for the cyclist as information on a display instrument 400, such as an HMI.

As has been stated in the description of the method, in additional specific embodiments, additional variables may also be taken into consideration in the actuation or regulation of damping element 410. Thus, using a suitable sensor 340, the treading force of the cyclist on the pedals or the torque generated may be detected in the pedal crank bearing. Using the recording of this variable, the curve over time of the cyclist's tread may be recorded and taken into consideration in the actuation.

Furthermore, the pedal position may be detected using the treading force or via a corresponding sensor 390. Thus, for example, in a position of the pedals in the first and third quadrants, in which the force on pedals 170 is particularly large, damping may be reduced. In contrast, in a position of the pedals in the second and fourth quadrants, in which, according to experience, the cyclist is able to exert less force on the pedals, damping may be increased or even maximized. In addition, there obviously also exists the possibility of making the setting of the damping a function of the (averaged) force or the (averaged) torque, via threshold values, for example.

Using a sensor 360, which is fastened, for example, as a strain gage in or on the bicycle frame, torsion induced by stress may be detected. Such torsions are an indication that the cyclist, while treading, utilizes the stresses which occur when, by pressing on the handlebar he uses his body and the frame as a lever for a more forceful treading on the pedals.

Besides that, sensors 380 could also be used which take into account travel parameters such as acceleration. Similar to special sensors 350 for recording the underground or sensors 370 for recording the inclination, acceleration sensors 390 may be used to record data on the underground, for instance on the currently present shocks. Thus, it is conceivable that one might reduce the damping in the case of a rather level roadway surface, according to trends, and thus to switch the connection between the front wheel and the handlebar (or even rear wheel/frame or seat/frame to rigid, while, in the case of a rough and uneven roadway surface, increasing or maximizing the damping.

In addition, damping element 410 itself may supply data which could be relevant for the actuation. Thus, an appropriate sensor, such as a displacement sensor in the damping element is able to detect what lift or what frequency the damped shocks have. Using these data, the damping may be optimized to the shocks that are present.

Of course, it may be provided that, for the damping elements that are associated with the front wheel, the seat and the rear wheel, different damping is able to be assigned at the same initial conditions. Thus, certain shocks are disturbing to the cyclist in the handlebar area which are not noticeable at the seat, or are not a health problem there. However, it may especially be provided at the seat that critical shocks to the bicycle, which may be a danger to health in the backbone, are able to be eliminated or at least reduced by specific automatic damping.

In one further exemplary embodiment, it may also be provided that a damping element be assigned to the handlebar, which is able to be actuated specifically as a function of the drive power of the cyclist.

Besides the applications of the present invention described above for a bicycle, the present invention may also be used for any other vehicle that is able to be propelled by a driver. Thus, the controllable damping elements may also be built into such as scooters, pedal cars, motorbikes, hand trucks, rollators, baby carriages and wheel chairs. In this context, the essential thing is that a variable is able to be recorded which represents the propelling power of the driver or guider.

What is claimed is:

1. A method for controlling a damping of a vehicle that is able to be propelled by a driver and includes at least one damping element capable of exhibiting a variable damping, comprising:
changing the damping as a function of a power variable representing a propelling power of the driver.

2. The method as recited in claim 1, wherein:
the vehicle includes a pedal crank bearing via which the vehicle is able to be propelled, and
the power variable represents a torque variable that represents a torque present at the pedal crank bearing.

3. The method as recited in claim 1, further comprising:
changing the damping additionally as a function of a curve over time of the power variable.

4. The method as recited in claim 1, further comprising:
changing the damping additionally as a function of a state variable that represents a condition of a roadway.

5. The method as recited in claim 4, wherein the condition of the roadway includes an unevenness of the roadway.

6. The method as recited in claim 1, further comprising:
changing the damping additionally as a function of a torsion variable representing a mechanical loading of a vehicle frame.

7. The method as recited in claim 6, wherein:
the vehicle frame includes a bicycle frame, and
the mechanical loading includes one of a torsional stress and a torsion of the bicycle frame.

8. The method as recited in claim 1, wherein in setting the damping, a treading of a cyclist on pedals located on the vehicle is taken into account, the damping being (i) one of reduced and set to zero during a heavy loading of the pedals, and (ii) one of increased and maximized during a weak loading of the pedals.

9. The method as recited in claim 8, wherein the damping at least one of:
is one of reduced and set to zero during a pedal position in one of a first quadrant and a third quadrant, and
is one of increased and maximized during a pedal position in one of a second quadrant and a fourth quadrant.

10. The method as recited in claim 1, wherein the damping at least one of:
is one of decreased and set to zero when the vehicle is moving one of on an uneven roadway and uphill, and
is one of increased and maximized when the vehicle is moving one of almost horizontally and downhill.

11. The method as recited in claim 1, wherein the vehicle is a bicycle.

12. A control unit for controlling a damping of a vehicle that is able to be propelled by a driver and includes at least one damping element capable of exhibiting a variable damping, comprising:
an arrangement for changing the damping as a function of a power variable representing a propelling power of the driver, wherein the arrangement at least one of controls and regulates the damping of a damping element on the vehicle, and wherein the arrangement changes the damping as a function of the power variable representing the propelling power of the driver.

13. The control unit as recited in claim 12, wherein the vehicle includes a bicycle.

14. The control unit as recited in claim 12, further comprising:
an arrangement for recording a condition of a roadway using a state variable; and
an arrangement for actuating the damping element as a function of the state variable.

15. The control unit as recited in claim 14, further comprising:
an arrangement for recording a pedal position of pedals on the vehicle usable for propelling it, wherein the damping of the damping element is at least one of:
one of reduced and set to zero during a pedal position in one of a first quadrant and a third quadrant, and
one of increased and maximized during a pedal position in one of a second quadrant and a fourth quadrant.

16. The control unit as recited in claim 15, further comprising:
an arrangement for recordings a variable that represents at least one of an inclination of the roadway and an acceleration of the vehicle on the roadway, wherein the damping of the damping element at least one of:
is one of decreased and set to zero when the vehicle is moving on one of an uneven roadway and uphill, and
is one of increased and maximized when the vehicle is moving almost one of horizontally and downhill.

17. A bicycle, comprising:
a control unit for controlling a damping of the bicycle that includes at least one damping element capable of exhibiting a variable damping, the control unit including:
an arrangement for changing the damping as a function of a power variable representing a propelling power of a driver, wherein the arrangement at least one of controls and regulates the damping of the damping element, wherein the arrangement changes the damping as a function of the power variable representing the propelling power of the driver, wherein in order to record the propelling power of a cyclist using a sensor, at least one of a torque in a pedal crank bearing and a treading force of the cyclist on pedals is recorded.

18. The bicycle as recited in claim 17, wherein the propelling power is recorded via force sensors.

19. The bicycle as recited in claim 17, further comprising:
a sensor for recording a torsion variable which represents one of a torsion stress and a torsion of a frame of the bicycle, wherein a control of the damping element is performed as a function of the torsion variable.

20. The bicycle as recited in claim 19, wherein the sensor includes a strain gage located one of in and on a frame of the bicycle.

21. The bicycle as recited in claim 17, wherein the damping element is assigned to at least one of a spring fork, a rear wheel suspension, a handlebar, and a bicycle seat.
